(19) United States
(12) Patent Application Publication
(10) Pub. No.: US 2009/0172454 A1
(43) Pub. Date: Jul. 2, 2009

(54) INFORMATION RECORDING DEVICE AND INFORMATION RECORDING METHOD

(75) Inventor: Yoriharu TAKAI, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/206,270

(22) Filed: Sep. 8, 2008

(30) Foreign Application Priority Data
Dec. 26, 2007 (JP) 2007-335131

(51) Int. Cl. G06F 12/08; G06F 1/28

(52) U.S. Cl. 713/340; 711/118; 711/E12.017

(57) ABSTRACT

An information recording device is a device for writing data to a disk-shaped recording medium and a cache memory and has a memory storing connection information showing a presence or an absence of a connection of an external power source; a determiner determining whether to write data recorded only in the cache memory to the disk-shaped recording medium based on the connection information; and a writer writing data recorded only in the cache memory to the disk-shaped recording medium according to the determination result.

### CROSS-REFERENCE TO RELATED APPLICATIONS

This application is based upon and claims the benefit of priority from the prior Japanese Patent Application No. 2007-335131, filed on Dec. 26, 2007; the entire contents of which are incorporated herein by reference.

### BACKGROUND OF THE INVENTION

1. Field of the Invention

The present invention relates to an information recording device and an information recording method, for writing data to a disk-shaped recording medium and a cache memory.

2. Description of the Related Art

Recently, an information recording device using a hard disk as a disk-shaped recording medium and a semiconductor storage medium as a cache memory has been developed. When there is data stored only in the cache memory, the data can also be stored in the disk-shaped recording medium (data synchronization) to improve data safety. A technology has been disclosed, in which, when a power source is disconnected before data in a cache memory is written to a magnetic disk device, the data can be written to the magnetic disk device after the power source is re-connected. Such data can be protected and reliability improves (see Reference 1 JP-A 6-348600 (KOKAI), claim 4 and paragraph 0056).

### BRIEF SUMMARY OF THE INVENTION

However, portability of devices has been improved and there are more and more devices that operate using batteries. Since writing data to a magnetic disk device relatively requires much electricity, in order to use the device for a long period of time, the writing to the magnetic disk device, that is, a synchronization process, is restricted while the device operates using a battery. According to the technology, a synchronization process cannot be restricted during a drive using a battery. In view of the above problem, the present invention has an object to provide an information recording device and an information recording method, capable of suppressing power consumption of a battery due to a synchronization process.

An information recording device according to an aspect of the present invention is an information recording device configured to write data to a disk-shaped recording medium and a cache memory, having a memory storing connection information showing a presence or an absence of a connection of an external power source; a determiner configured to determine whether to write data recorded only in the cache memory to the disk-shaped recording medium based on the connection information; and a writer configured to write data recorded only in the cache memory to the disk-shaped recording medium according to the determination result.

An information recording method according to an aspect of the present invention is an information recording method in an information recording device configured to write data to a disk-shaped recording medium and a cache memory, and the information recording method has writing data to both of the disk-shaped recording medium and the cache memory or only to the cache memory according to accessibility information showing an allowance or a prohibition of an access to the disk-shaped recording medium; determining whether to write data recorded only in the cache memory to the disk-shaped recording medium based on a presence or an absence of a predetermined detection; and writing data recorded only in the cache memory to the disk-shaped recording medium according to the determination result.

### BRIEF DESCRIPTION OF THE DRAWINGS

FIG. 1 is a block diagram showing an information recording and reproducing system according to a first embodiment of the present invention;

FIG. 2 is a flowchart showing an example of an operation procedure of an information recording device;

FIG. 3 is a flowchart showing an example of details of a writing process in step S14 of FIG. 2;

FIG. 4 is a flowchart showing another example of details of the writing process in step S14 of FIG. 2; and

FIG. 5 is a block diagram showing an electronic device according to a second embodiment of the present invention.

### DETAILED DESCRIPTION OF THE INVENTION

Embodiments of the present invention will be described with reference to the drawings.

### First Embodiment

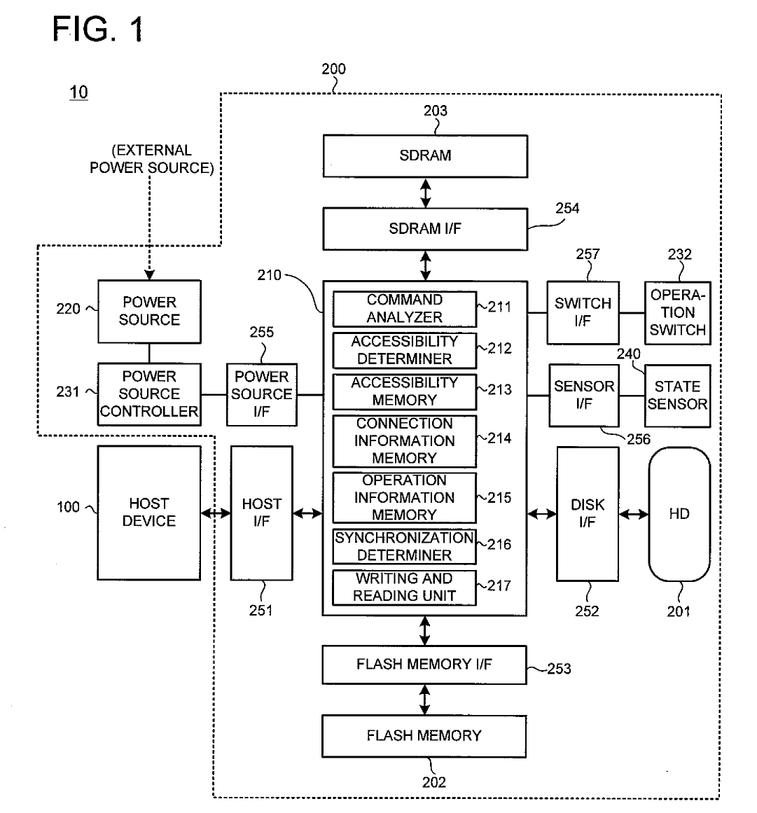

FIG. 1 is a block diagram showing an information recording and reproducing system 10 according to a first embodiment of the present invention. The information recording and reproducing system 10 has a host device 100 and an information recording device 200.

The information recording device 200 has a hard disk (HD) 201, a flash memory 202, an SDRAM 203, a main controller 210, a power source 220, a power source controller 231, an operation switch 232, a state sensor 240, a host interface (I/F) 251, a disk interface (I/F) 252, a flash memory interface (I/F) 253, an SDRAM interface (I/F) 254, a power source interface (I/F) 255, a sensor interface (I/F) 256 and a switch interface (I/F) 257.

The host device 100 is a device for writing information to or reading information from the information recording device 200 and serves like a control unit in a personal computer, for example. The host device 100 sends a command to the main controller 210 via the host interface 251. The host device 100 receives data from the main controller 210 via the host interface 251.

The host interface 251 is adapted to an interface compliant with an ATA (Advanced Technology Attachment) standards such as Parallel ATA (PATA), Serial ATA (SATA) and CE-ATA. Further, the host device 100 and the host interface 251 can be connected using a standard other than the ATA standards, such as the USB (Universal Serial Bus) standards. Or, the host device 100 and the host interface 251 can be connected via a LAN (Local Area Network). Here, the host interface 251 can have a protocol converter for converting protocols between signals compliant with different standards, according to need.

The main controller 210 sends data to and receives data from the HD 201, flash memory 202 and SDRAM 203 via the disk interface 252, flash memory interface 253, SDRAM interface 254, respectively.

The HD 201 has a magnetic disk, a spindle motor, a magnetic head, and an arm. The magnetic disk is a disk-shaped recording medium for recording information. The spindle motor rotates the magnetic disk. The magnetic head writes data to and read data from the magnetic disk. The arm holds the magnetic head and moves it on the magnetic disk.

The flash memory 202 is used as a cache when recording data e HD 201. Thus, the flash memory 202 has a cache table in addition to a writing area for writing data. The cache table shows cache information (an address 1, an address 2 and synchronization information) The address 1 and address 2 are addresses on the flash memory 202 and the HD 201, respectively (for example, physical addresses). The synchronization information shows whether or not data corresponding to the address 1 of the flash memory 202 is written on the HD 201 (necessity of synchronization). As described below, data can be written in the flash memory 202 but not in the HD 201.

The SDRAM 203 is used as a buffer when recording data to the HD 201. To the data recorded in the HD 201 and flash memory 202, an error correcting code is added. An ECC process is performed on the data recorded in the flash memory and the hard disk to provide an error correction when the data is reproduced.

When data in the host device 100 is written to the HD 201, the data is written via the flash memory 202 and the SDRAM 203. For example, the data is written via following orders:
(1) a path to the HD 201 via the SDRAM 203;
(2) a path to the HD 201 via the flash memory 202;
(3) a path to the HD 201 via the flash memory 202 and SDRAM 203;
(4) a path to the HD 201 via the SDRAM 203 and flash memory 202; and
(5) a path to the HD 201 via the SDRAM 203, flash memory 202 and SDRAM 203. In cases of (2) to (5), cache information is added to the cache table (addition of an entry).

When data in the HD 201 is written to the host device 100, the data is written via the flash memory 202 and the SDRAM 203. For example, the data is written via following orders:
(1) a path to the host device 100 from the HD 201 via the SDRAM 203;
(2) a path to the host device 100 from the HD 201 via the flash memory 202;
(3) a path to the host device 100 from the HD 201 via the flash memory 202 and SDRAM 203;
(4) a path to the host device 100 from the HD 201 via the SDRAM 203 and flash memory 202; and
(5) a path to the host device 100 from the HD 201 via the SDRAM 203, flash memory 202 and SDRAM 203.

The flash memory 202 is a nonvolatile memory but is capable of electrically deleing, rewriting and modifying data. The flash memory 202 can be consumed when the number of rewriting increases and this can cause an error (for example, a read disturb or a data retention) and the content of the rewrite can be destroyed. As a guarantee of the performance of the flash memory 202, the number of rewriting is defined as about one hundred thousand times, for example.

The writing area of the flash memory 202 is divided into a pinned area and an unpinned area.

The pinned area is an area that is formed when a command transmitted from the host device 100 and the command specifies the flash memory 202 as a data writing destination. Subsequently to the the command (pinned command), a logic block address (LBA) is specified. When the host device 100 sends a pinned command and specifies the pinned area as an address (pinned LBA), data is written in the pinned area.

On the other hand, the unpinned area is an area in which data is transferred and stored according to an independent determination by the main controller 210 when a data writing destination is not specified by the host device 100. When the flash memory 202 is used as a cache memory, data is written in the unpinned area. In this case, the host device 100 is not required to confirm the address of the cache memory 202 and specifies an address in the HD 201.

The flash memory 202 can be a memory compliant with a standard of “Non Volatile Cache Command Proposal for ATA8-ACS.”

The power source 220 has a battery for accumulating and supplying electric power from an external power source. The power source controller 231 detects the external power source connected to the power source 220. For example, the power source controller 231 recognizes that a terminal of the external power source is plugged or unplugged to an external power source connector of the power source 220. In other words, the power source controller 231 serves as a detector for detecting a connection of the external power source to the power source 220.

The detection result (a connection of the external power source) in the power source controller 231 is notified to the main controller 210 via the power source interface 255. A control signal or a command can be used for the notification. As the command, a dedicated command or an unused part (argument part) of an existing command can be used. Further, as a substitute for the control signal or command, a physical switch can be used to notify the detection result to the main controller 210.

The operation switch 232 is an input means for inputting information corresponding to the detection of the external power source connected to the power source 220. In other words, when the operation switch 232 is operated, a process (for example, a synchronization between the flash memory 202 and the HD 201) to be executed in response to a detection of the external power source connected to the power source 220 is executed.

The state sensor 240 is a sensor for detecting a state of the information recording device 200 (for example, vibration, acceleration, temperature and atmosphere pressure). This detection result is Used in an accessibility determiner 212 to determine a prohibition or an allowance of an access to the HD 201. When the state of the information recording device 200 is not suitable for operations of the HD 201 (for example, the acceleration is greater than a predetermined value), an access to the HD 201 is prohibited. A user can input to the state sensor 240 whether the state is good or not by using the operation switch and the like.

The main controller 210 has a command analyzer 211, an accessibility determiner 212, an accessibility memory 213, a connection information memory 214, an operation information memory 215, a synchronization determiner 216 and a writing and reading unit 217.

The command analyzer 211 analyzes the command transmitted from the host device 100. This command is used for instructing to write data, instructing to read data, specifying data size, transferring data, memorizing and instructing to read information. The command analyzer 211 serves as a writing detector for detecting a writing command from the host device 100.

The accessibility determiner 212 determines a prohibition or an allowance of an access the HD 201 based on the detected result of the state sensor 240 and modifies memorized contents in the accessibility memory 213. The accessibility memory 213 stores the determined result of the accessibility determiner 212.

The connection information memory 214 stores the detection result of the connection of the external power source, which is notified by the power source controller 231. The connection information memory 214 serves as a memory for storing connection information showing a presence or an absence of a connected external power source.

The operation information memory 215 stores the operation result of the operation switch 232. In other words, the operation information memory 215 serves as a second memory for storing accessibility information showing a prohibition or an allowance of an access to the disk-shaped recording medium.

The synchronization determiner 216 determines whether to write the data recorded in the flash memory 202 to the HD 201 (whether to synchronize the flash memory 202 and HD 201). The synchronization determiner 216 serves as a determiner for determining whether to write the data recorded only in the cache memory to the disk-shaped recording medium, based on the connection information.

The writing and reading unit 217 writes data to and reads data from the HD 201, flash memory 202 and SDRAM 203. The writing and reading unit 217 serves as a writer for writing data recorded only in the cache memory to the disk-shaped recording medium. The writing and reading unit 217 serves as a second writer for writing data to both of the disk-shaped recording medium and cache memory or only to the cache memory.

The writing and reading unit 217 also deletes data from the HD 201, flash memory 202 and SDRAM 203. In other words, the writing and reading unit 217 also serves as a deleter for deleting data written in the disk-shaped recording medium from the cache memory.

### (Operation of the Information Recording Device 200)

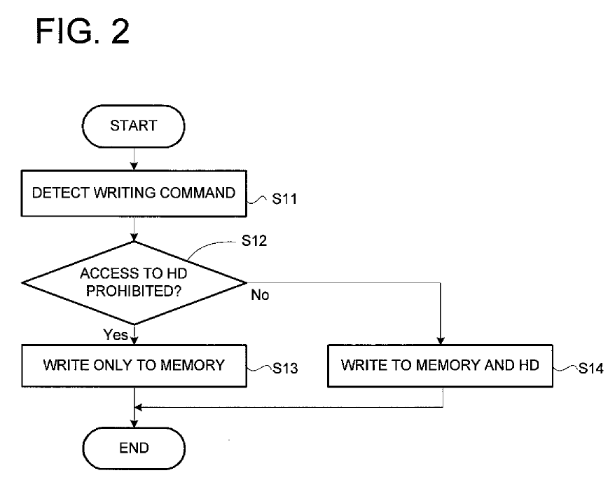

An operation procedure of the information recording device 200 will be described. FIG. 2 is a flowchart showing an example of an operation procedure of the information recording device 200.

### (1) Detecting a Writing Command (Step S11)

The command analyzer 211 detects a writing command sent from the host device 100. In other words, the host device 100 sends a writing command to the main controller 210 to instruct to write data and the command analyzer 211 detects the command.

### (2) Confirming a Presence or an Absence of a Prohibition of an Access to the HD 201 (Step S12)

A presence or absence of an access to the HD 201 is confirmed. In other words, the determination result stored in the accessibility memory 213 is referred and it is confirmed whether the determination result shows a prohibition or an allowance regarding an access to the HD 201.

### (3) Writing Data to the Flash Memory 202 (Step S13)

When a prohibition of an access to the HD 201 is confirmed, the data is not written to the HD 201 and written only to the flash memory 202 (or also to the SDRAM 203).

### (4) Writing Data to the HD 201 and the Flash Memory 202 (Step S14)

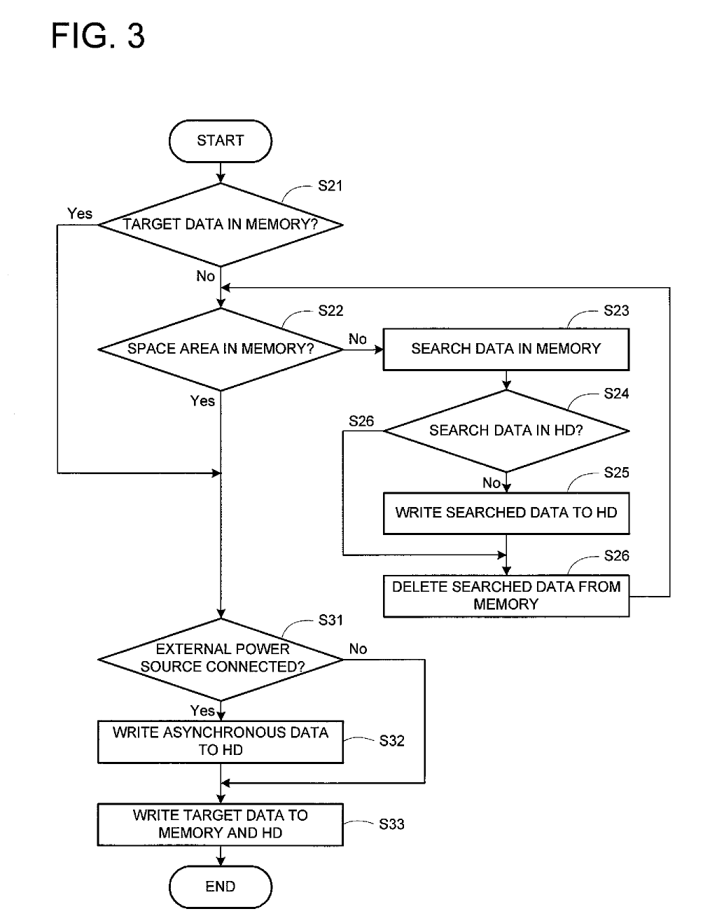

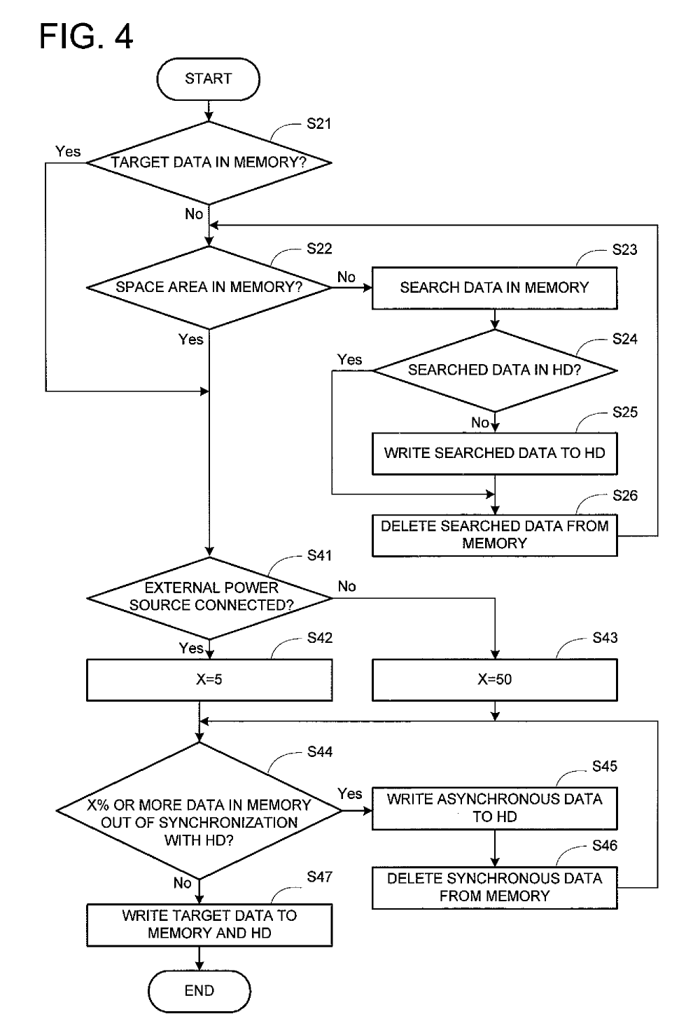

When an allowance of an access to the HD 201 is confirmed, the data is written to the HD 201 and the flash memory 202. Details of this process will be described with reference to FIGS. 3 and 4.

The access target (for example, a data writing destination) is not determined only by the determination result stored in the accessibility memory 213. For example, when writing in step S14, it is determined whether to write to both of the HD 201 and the flash memory 202 or to one of the HD 201 and the flash memory 202. The controller 210 selects an access target which can quickly response to the host device 100, has an impact resistance and can suppress power consumption. For example, when the magnetic disk does not rotate in the HD 201 (rotation standby state), the flash memory 202 is selected as a writing destination. This process is same in later described steps S33 and S47.

Since the flash memory 202 does not have a drive element, in general, the flash memory 202 has a great impact resistance during an access and suppresses power consumption. On the other hand, in a magnetic storage device such as the HD 201, a magnetic head physically accesses data on a rotated medium (magnetic disk), such magnetic storage does not have a great impact resistance during an access and can consume much power.

Thus, when an access to the HD 201 is prohibited based on the determination result stores in the accessibility memory 213, it is possible to improve the impact resistance and reduce power consumption while using the HD 201.

However, when the control is maintained and a writing operation is continued in a state that the access to the HD 201 is prohibited, an amount of data existing only in the flash memory 202 and not in the HD 201 (asynchronous data) increases. In consideration of a limit of the number of rewritings of the flash memory 202 and the like, when data is stored only in the flash memory 202, it is not mean that the data is completely stored.

As described below, according to the present embodiment, corresponding to a presence or an absence of a connected external power source, data existing only in the flash memory 202 is written to the HD 201 (data synchronization (data flash)). As a result, the data can be maintained more securely. In other words, even when the data in the flash memory 202 is broken, data in the HD 201 can be used in response to a request for reading data from the host device 100.

### A. Synchronization Corresponding to a Presence or an Absence or a Connected External Power Source (1)

FIG. 3 is a flowchart showing an example of details of a writing process in S14.

### (1) Determining Whether Writing Target Data Exists in the Flash Memory 202 (Step S21)

It is determined whether writing target data exists in the flash memory 202 or not. When existing data is rewritten, an address of the writing target data can exist in the flash memory 202.

### (2) Confirming a Space Area in the Flash Memory (Step S22)

When writing target data does not exist in the flash memory 202 (when existing data is not rewritten), it is confirmed whether there is a space area corresponding to the data written to the flash memory 202 or not.

### (3) Maintain a Space Area in the Flash Memory 202 (Steps S23 to S26)

When there is not a space area corresponding to the data to be written to the flash memory 202, a space area is added to write the data to the flash memory 202 as follows.

The data in the flash memory 202 is searched and when the searched data also exists in the HD 201, the data is deleted from the flash memory 202. When the searched data does not exist in the HD 201, the data is written to the HD 201 and deleted from the flash memory 202.

In these processes, the cache table on the flash memory 202 can be used. In other words, searching data on the flash memory 202, confirming a presence in the HD 201 and deleting the data are all executed on the cache table. When the presence in the HD 201 is confirmed, the synchronization information can be used. Further, the deleting data from the flash memory 202 is executed by deleting the cache information (entry) from the cache table. In other words, when the entry in the cache table is deleted, it is not required to delete the actual data in the writing area.

### (4) Confirming a Presence or an Absence of a Connected External Power Source (Step S31)

A presence or an absence of a connected external power source is confirmed. In other words, the detection result stored in the connection information memory 214 is referred and it is confirmed whether the detection result shows a presence or an absence of a connected external power source.

### (5) Writing Asynchronous Data to the HD 201 (Step S32)

When the external power source is connected, data which exists only in the f lash memory 202 and does not exist in the HD 201 (asynchronous data) is written to the HD 201 (step S31). In other words, data is synchronized between the flash memory 202 and the HD 201 (maintaining a consistency). The process in step S32 can be executed in above described step S23 to S25.

In this case, all data in the flash memory 202 can be provided in the HD 201 (100% synchronization). The synchronization can be stopped at a predetermined rate. The cache table is updated corresponding to the data synchronization.

Here, the data written in the HD 201 (synchronized data) can be deleted from the flash memory 202. In this case, a lot of space areas are formed in the flash memory 202 as the data is deleted from the flash memory 202. The execution of this data deletion can be detected as an occurrence of a cache miss. For example, when a “Query NV Cache Misses” command is used, an occurrence of a cache miss corresponding to a space area formation of the present embodiment can be detected. In other words, the frequency of occurrence of cache miss varies according to a presence or an absence of a connected external power source.

### (6) Writing the Writing Target Data (Step S33)

Writing target data is written to the flash memory 202 and the HD 201.

Here, corresponding to a presence or an absence of a connected external power source, both of the flash memory 202 and HD 201 or only the flash memory 202 can be selected as a writing destination. In other words, when an external power source is connected, data is written to both of the flash memory 202 and the HD 201. When the external power source is not connected, data is written only to the flash memory 202. Corresponding to a pretense or an absence of a connected external power source, that is, a necessity of driving a battery, writing to the HD 201 can be omitted to reduce power consumption when driving using the battery.

As described above, since data is synchronized between the flash memory 202 and the HD 201 (the data cached in the flash memory 202 is written to the HD), data can be stored in both of the flash memory 202 and the HD 201. As a result, even when data in the flash memory 202 is broken, the data can be recovered by referring to the data in the HD 201.

The following is the reason why the data is synchronized corresponding to a presence or an absence of the connection of the external power source. In the present embodiment, the HD 201 operates using battery of the power source 220. Thus, when the external power source is not connected to the power source 220, access to the HD 201 is controlled to reduce power consumption. As a result, time for driving by the battery can be maintained. On the other hand, when the external power source is connected to the power source 220, it is not very important to control the access to the HD 201 and consider the power consumption. In other words, since the synchronization process is executed corresponding to the connection of the external power source, it is possible to reduce power consumption when operating the battery and also to maintain safety of data when the external power source is connected.

### B. Synchronization Corresponding to a Presence of an Absence of a Connected the External Power Source (2)

FIG. 4 is a flowchart showing another example of details of the writing process in step S14. The process in the step S21 to S26 are same as those of FIG. 3, description of the processes are omitted here.

### (1) Setting a Synchronization Start Parameter (Steps S41 to S43)

A synchronization start parameter is set corresponding to a presence or an absent of a connected external power source. In this example, the synchronization start parameter is a reference value X of a ratio A regarding asynchronous data on the flash memory 202 and the value is modified corresponding to a presence of an absence of the connected external power source. Here, the reference value X of the ratio A is set to be 5% when the external power source is connected and the reference value X of the ratio A is set to be 50% when the external power source is not connected. The ratio A of asynchronous data on the flash memory 202 can be calculated based on a ratio of a no-synchronization state in the synchronization information.

When the reference value X of the ratio is reduced and the external power source is connected, a possibility of a start of a data flash is increased. Since it is determined whether to start a data flash based on only a presence or an absence of a connected external power source in the example shown in FIG. 3, it becomes easier to improve flexibility of processes and maintain a balance between a power consumption and data safety.

As a substitute for the ratio of the asynchronous data, an amount of asynchronous data can be used as the synchronization start parameter.

### (2) Writing Asynchronous Data to the HD 201 (Steps S44 to S46)

When the ratio A of the asynchronous data on the flash memory 202 is greater than the reference value X (step S44), the asynchronous data is written to the HD 201 (step S45). In other words, data is synchronized between the flash memory 202 and the HD 201 (maintaining a consistency). The step S45 can be executed by the processes in above described steps S23 to S25.

This writing is repeated until the ratio A of the asynchronous data becomes smaller than the reference value X. In other words, according to the example shown in FIG. 3, when the data synchronization starts, the process is more reliable, compared to a case that data is synchronized until a 100% synchronization is obtained. However, when the data synchronization process starts, the data synchronization can be repeated until a 100% synchronization is obtained.

According to the example shown in FIG. 4, data written in the HD 201 (synchronized data) is deleted from the flash memory 202. As described above, deletion of the synchronized data is executed by deleting the cache information (entry) from the cache table. As a substitute for the deletion of the data, the synchronized data can be maintained in the flash memory 202 (omission of step S46). With this structure, data is stored in two places and data maintenance becomes more assured.

The data deletion can be detected as an occurrence of a cache miss by using, for example, a “Query NV Cache Misses” command. The frequency of occurrence of cache miss varies according to a presence or an absence of a connection of the external power source.

(3) Writing the Writing Target Data (step S47)

Writing target data is written to the flash memory 202 and HD 201. Here, as described in step S33 of FIG. 3, both of the flash memory 202 and the HD 201 or only the flash memory 202 can be selected as the writing destination, corresponding to a presence or an absence of z connected external power source.

### C. Synchronization Corresponding to a Presence or an Absence of a Connected External Power Source (3)

According to the above items A and B, it is considered an assumption that the detection of a writing command and the operation switch 232 are in an off state. In other words, when the writing command is detected, it is determined whether to start synchronization. On the other hand, regardless of the detection of the writing command, it can be determined whether to start synchronization when the external power source is connected.

### D. Synchronization Corresponding to the Operation Switch 232

When the operation switch 232 is turned on, a process same as the process in response to the detection of a connection of the external power source can be executed. For example, regardless of a detection of a writing command and a connection of the external power source, data synchronization between the flash memory 202 and the HD 201 can be started. More specifically, when the operation switch 232 is turned on, the synchronization process shown in step S32 of FIG. 3 can be executed. Here, the data written to the HD 201 (synchronized data) can be deleted from the flash memory 202 according to need. Further, similarly to the case that a connection of the external power source is detected, processes in steps S42 to S46 of FIG. 4 can be executed.

### Second Embodiment

A second embodiment of the present invention will be described.

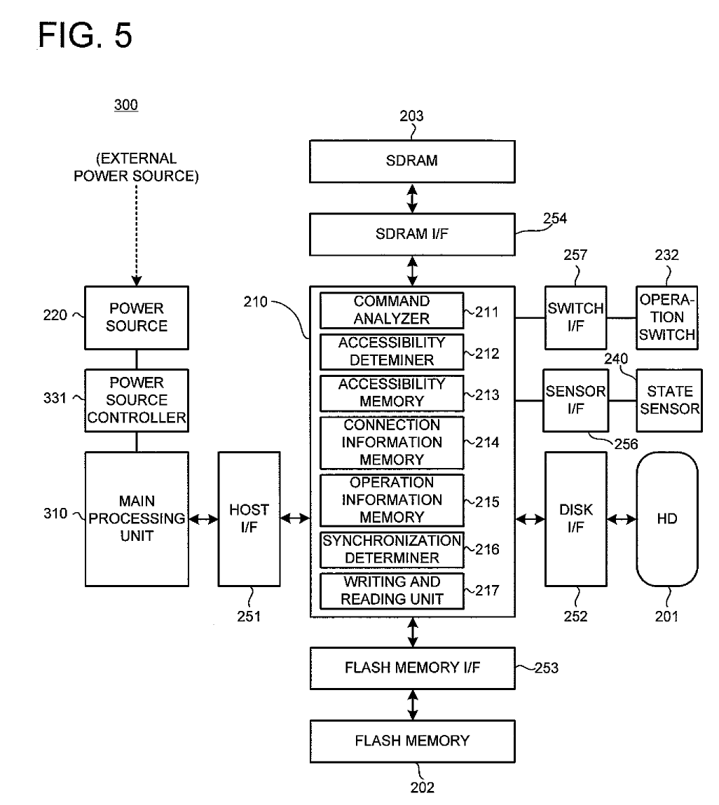

FIG. 5 is a block diagram showing an electronic device 300 according to a second embodiment of the present invention. The electronic device 300 has a main processing unit 310, a hard disk (HD) 201, a flash memory 202, an SDRAM 203, a main controller 210, a power source 220, a power source controller 331, an operation switch 232, a state sensor 240, a host interface 251, a disk interface 252, a flash memory interface 253, an SDRAM interface 254, a sensor interface 256 and a switch interface 257.

The electronic device 300 is applicable to various devices such as an audio player, a video player, a game machine, a personal computer and an electronic notebook, for example. Compared to the information recording and reproducing system 10 having two devices of the host device 100 and the information recording device 200, the electronic device 300 is made as an integrated device.

The electronic device 300 has the main processing unit 310 as a substitute for the host device 100 in the information recording and reproducing system 10. The main processing unit 310 performs basic functions of the electronic device 300 (for example, an audio reproduce function, a video reproduce function and a game function).

The electronic device 300 does not have the power source interface 255 and the power source controller 331 is connected to the main processing unit 310. In other words, the detection result of the connected external power source in the power source controller 331 is notified to the main controller 210 via the main processing unit 310. For this notification, a control signal or a command from the main processing unit 310 can be used. As the command, a dedicated command or an unused part (argument part) of an existing command can be used. Further, as a substitute for the control signal or command, a physical switch can be used to notify the detected result to the main controller 210. Here, similarly to the first embodiment, the detected result can be notified to the main controller 210 via a power source interface, not the main processing unit 310.

An operation procedure of the electronic device 300 is basically the same as that of the information recording device 200 so the description will be omitted here.

### Other Embodiment

Embodiments of the present invention are not limited to the above-described embodiments. The above-described embodiments can be expanded and modified, and the expanded and modified embodiments are also included in the technical range of the present invention.

What is claimed is:

1. An information recording device configured to write data to a recording medium and a cache memory, comprising:
a memory configured to store connection information indicating a connection status of an external power source;
a determining module configured to determine whether to write data recorded only in the cache memory to the recording medium based on the connection information; and
a writer configured to write the data in the cache memory to the recording medium based on the determination result.

2. The information recording device of claim 1, further comprising:
an internal power source configured to store power from an external power source and to supply the power to the device; and
a detector configured to detect a connection between the external power source and the internal power source,
wherein the connection information is indicative of a detection result by the detector.

3. The information recording device of claim 1,
wherein the connection information is indicative of a of a connection status of an external power source at a host device connected to the information recording device.

4. The information recording device of claim 1, further comprising:
an operation switch,
wherein the determining module is configured to determine whether to write the data recorded only in the cache memory to the recording medium based on an operation of the operation switch.

5. The information recording device of claim 1, further comprising:
a second memory configured to store an accessibility information indicative of a granted status of access to the recording medium; and
a second writer configured to write data to either both of the recording medium and the cache memory, or only to the cache memory, based on the accessibility information.

6. The information recording device of claim 1, further comprising:
a deleting module configured to delete data in the recording medium written by the writer from the cache memory.

7. The information recording device of claim 1, wherein the determining module comprises:
a first determining module configured to determine a value based on the connection information; and
a second determining module configured to determine whether to write the data recorded only in the cache memory to the recording medium based on a result of comparing an amount or ratio of data recorded only in the cache memory with the determined value.

8. The information recording device of claim 1, further comprising:
a writing command detector configured to detect a writing command from a host device connected to the information recording device,
wherein the determiner is configured to determine whether to write or not based on the detected writing command.

9. An information recording method in an information recording device configured to write data to a recording medium and a cache memory, the information recording method comprising:
writing data to either both of the recording medium and the cache memory, or only to the cache memory based on accessibility information indicative of a granted status of access to the recording medium;
determining whether to write data recorded only in the cache memory to the recording medium based on a status of a predetermined detection; and
writing data recorded only in the cache memory to the recording medium based on the determination result.

10. The information recording method of claim 9, further comprising:
detecting a connection between an external power source and an internal power source configured to store electricity and to supply the electricity,
wherein the connection information is indicative of the detection result.

11. The information recording method of claim 9,
wherein the connection information is indicative of a connection status of the external power source at a host device connected to information recording device.

12. The information recording method of claim 9, further comprising:
determining whether to write the data recorded only in the cache memory to the recording medium based on an operation of an operation switch.

13. The information recording method of claim 9, further comprising:
writing data to either both of the recording medium and the cache memory, or only to the cache memory based on an accessibility information indicative of a granted status of access to the recording medium.

14. The information recording method of claim 9, further comprising:
deleting data written in the recording medium from the cache memory.

15. The information recording method of claim 9, wherein the determining step comprises:
determining a value based on the connection information, and
determining whether to write the data recorded only in the cache memory to the recording medium based on a result of comparing an amount or a ratio of data recorded only in the cache memory with the determined value.

16. The information recording method of claim 9, further comprising:
detecting a writing command from a host device connected to the information recording device,
wherein whether to write or not is determined based on the detected writing command.
